(19) United States
(12) Patent Application Publication
(10) Pub. No.: US 2010/0177098 A1
(43) Pub. Date: Jul. 15, 2010

(54) IMAGE GENERATION SYSTEM, IMAGE GENERATION METHOD, AND COMPUTER PROGRAM PRODUCT

(75) Inventor: Satoru OOUCHI, Yokohama-shi (JP)

Correspondence Address: OLIFF & BERRIDGE, PLC, P.O. BOX 320850, ALEXANDRIA, VA, 22320-4850, US

(73) Assignee: CELLIUS, INC., Tokyo (JP)

(21) Appl. No.: 12/647,987

(22) Filed: Dec. 28, 2009

(30) Foreign Application Priority Data
Jan. 14, 2009 (JP) 2009-005597

(51) Int. Cl. G06T 15/20

(52) U.S. Cl. 345/427

(57) ABSTRACT

An image generation system includes a communication section that receives drawn image data from each of a plurality of area processing units. Each of the plurality of area processing units performs a control process that controls an object positioned in a corresponding area among a plurality of areas formed by dividing a virtual three-dimensional space, performs a drawing process that draws an image of the corresponding area viewed from a virtual camera, and transmits drawn image data obtained by the drawing process. The image generation system includes an image synthesis section that performs an image synthesis process based on the drawn image data received by the communication section to generate a display image viewed from the virtual camera.

Japanese Patent Application No. 2009-005597 filed on Jan. 14, 2009, is hereby incorporated by reference in its entirety.

### BACKGROUND

The present invention relates to an image generation system, an image generation method, a computer program product, and the like.

In recent years, a system that generates an image (video (movie)) by parallel computing has been proposed (e.g., JP-A-2005-334110). An image generation method that utilizes parallel computing may be classified into a first method that generates a CG image by long pre-rendering using a large-scale system, and a second method that generates an interactive image by hardware that is closely coupled on a relatively small scale.

When using the first method, the amount of data calculated by physical calculations, motion control, or the like increases to a large extent as the number of drawing target objects increases. It is very difficult to share such a large amount of data and draw an image within the screen update time using the shared data. Therefore, it is difficult to generate an image in real time, and it is necessary to generate a CG image by pre-rendering.

The second method does not suffer from the problem that occurs when using the first method. However, since the amount of information that can be handled using the second method is small, the number of objects that can be drawn within the screen update time is small, and the quality of the output image tends to deteriorate.

### SUMMARY

According to one aspect of the invention, there is provided an image generation system comprising:

a communication section that receives drawn image data from each of a plurality of area processing units, each of the plurality of area processing units performing a control process that controls an object positioned in a corresponding area among a plurality of areas formed by dividing a virtual three-dimensional space, performing a drawing process that draws an image of the corresponding area viewed from a virtual camera, and transmitting the drawn image data obtained by the drawing process; and

an image synthesis section that performs an image synthesis process based on the drawn image data received by the communication section to generate a display image viewed from the virtual camera.

According to another aspect of the invention, there is provided an image generation method comprising:

causing each of a plurality of area processing units to perform a control process that controls an object positioned in a corresponding area among a plurality of areas, the plurality of areas been formed by dividing a virtual three-dimensional space;

causing each of the plurality of area processing units to perform a drawing process that draws an image of the corresponding area viewed from a virtual camera;

receiving drawn image data when each of the plurality of area processing units has transmitted the drawn image data obtained by the drawing process; and

performing an image synthesis process based on the received drawn image data to generate a display image viewed from the virtual camera.

According to another aspect of the invention, there is provided a computer program product storing a program code that causes a computer to execute the above information generation method.

### BRIEF DESCRIPTION OF THE DRAWINGS

FIG. 1 shows a configuration example of an information generation system according to one embodiment of the invention.

FIG. 2 is a view illustrative of a plurality of areas and a plurality of area processing units that take charge of the plurality of areas.

FIG. 3 shows a configuration example of an area processing unit.

FIG. 4 shows a hardware configuration example of an information generation system.

FIG. 5 is a view illustrative of an image generation method of an image generation system.

FIG. 6 is a data flowchart illustrative of an operation according to one embodiment of the invention.

FIG. 7 is a data flowchart illustrative of an operation according to one embodiment of the invention.

FIGS. 8A and 88 are views illustrative of a process performed when a moving object has left the area.

FIG. 9 is a view illustrative of an enlarged area setting method.

FIGS. 10A and 10B are views illustrative of an image generation method according to one embodiment of the invention.

FIG. 11 is a view illustrative of an image generation method according to one embodiment of the invention.

FIG. 12 is a view illustrative of another example of an image generation method according to one embodiment of the invention.

FIG. 13 is a view illustrative of a method that provides a plurality of reception buffers.

FIG. 14 is a view illustrative of a method that divides a reception buffer into a plurality of segmented areas.

### DESCRIPTION OF EXEMPLARY EMBODIMENTS

Several aspects of the invention may provide an image generation system, an image generation method, a computer program product, and the like that can generate a high-quality image by effectively utilizing a plurality of area processing units.

According to one embodiment of the invention, there is provided an image generation system comprising:

a communication section that receives drawn image data from each of a plurality of area processing units, each of the plurality of area processing units performing a control process that controls an object positioned in a corresponding area among a plurality of areas formed by dividing a virtual three-dimensional space, performing a drawing process that draws an image of the corresponding area viewed from a virtual camera, and transmitting the drawn image data obtained by the drawing process; and

an image synthesis section that performs an image synthesis process based on the drawn image data received by the communication section to generate a display image viewed from the virtual camera.

According to this embodiment, each area processing unit performs the control process that controls an object positioned in the corresponding area among the plurality of areas formed by dividing the virtual three-dimensional space, and a drawing process that draws an image of the corresponding area viewed from the virtual camera. Each area processing unit transmits the drawn image data obtained by the drawing process. The communication section receives the drawn image data transmitted from each area processing unit, and the image synthesis section performs the image synthesis process based on the drawn image data received by the communication section to generate a display image viewed from the virtual camera. According to this configuration, the object control process and the object drawing process on each area are performed by the area processing unit that takes charge of that area. The image synthesis section can generate a display image by merely performing the image synthesis process based on the drawn image data received from each area processing unit. Therefore, a high-quality image can be generated by effectively utilizing a plurality of area processing units.

The image generation system may further comprise:

a management section that manages the virtual camera,

the management section may transmit virtual camera information to each of the plurality of area processing units, and

each of the plurality of area processing units may draw an image of the corresponding area viewed from the virtual camera based on the virtual camera information received from the management section.

According to this configuration, the virtual camera can be controlled by the management section, and each area processing unit can draw an image of the corresponding area based on the virtual camera information received from the management section.

In the image generation system,

the management section may acquire the virtual camera information based on information about an operation object that is operated by an operator, and may transmit the virtual camera information to each of the plurality of area processing units.

According to this configuration, the virtual camera information is set based on the information about the operation object operated by the operator so that an image of each area viewed from the virtual camera can be drawn.

The image generation system may further comprise:

the plurality of area processing units.

The image generation system may further comprise:

a management section that manages an operation object that is operated by an operator,

an area processing unit among the plurality of area processing units that controls the operation object may transmit information about the operation object after the control process to the management section.

According to this configuration, the management section can acquire the information about the operation object by causing the area processing unit that takes charge of the area where the operation object is positioned to transmit the information about the operation object after the control process to the management section, for example. This makes it possible to generate a display image that changes corresponding to the operation object operated by the operator, for example.

In the image generation system,

when a moving object has moved from one area to another area, a first area processing unit among the plurality of area processing units may notify a second area processing unit among the plurality of area processing units with information about the moving object, the first area processing unit taking charge of the area where the moving object has been positioned, the second area processing unit taking charge of the other area.

According to this configuration, when a moving object has moved from one area to another area, the area processing unit that takes charge of the area to which the moving object has moved can acquire the information about the moving object, and can perform the control process and the drawing process on the moving object, for example.

In the image generation system,

the first area processing unit may notify the second area processing unit with at least one of movement information and control information about the moving object as the information about the moving object.

According to this configuration, the area processing unit that takes charge of the other area can implement the control process on the moving object using the acquired movement information or control information, for example.

In the image generation system, each of the plurality of area processing units may include a model data storage section that stores model data of a moving object that moves across an area boundary.

According to this configuration, since the model data of the moving object need not be transmitted even when the moving object has moved across the area boundary, the communication load can be reduced.

In the image generation system,

the communication section may receive image data and depth data from each of the plurality of area processing units as the drawn image data, and

the image synthesis section may perform the image synthesis process based on the depth data received by the communication section.

According to this configuration, a hidden surface removal process or the like can be implemented when synthesizing the drawn images by effectively utilizing the depth data generated by each area processing unit.

In the image generation system,

the image synthesis section may perform the image synthesis process based on the drawn image data in the order from an area among the plurality of areas that is positioned away from the virtual camera.

According to this configuration, the drawn images can be synthesized by a simple process.

In the image generation system,

the communication section may receive drawing area identification information from each of the plurality of area processing units, the drawing area identification information specifying a different drawing area in the display image where an image has been drawn respectively by each of the plurality of area processing units, and

the image synthesis section may synthesize an image based on the drawn image data received respectively from each of the plurality of area processing units in the drawing area specified by the drawing area identification information received respectively from each of the plurality of area processing units.

According to this configuration, since it suffices that the image synthesis section merely write the drawn image in the area specified by the drawing area identification information, the processing load imposed on the image synthesis section can be reduced.

The image generation system may further comprise:

a plurality of reception buffers, a drawn image that has been drawn by each of the plurality of area processing units being written into the plurality of reception buffers; and

a display buffer,

the image synthesis section may write an image obtained by synthesizing the drawn images written into the plurality of reception buffers into the display buffer.

According to this configuration, the drawn image data can be written into each reception buffer while minimizing the wait time.

The image generation system may further comprise:

a reception buffer that is divided into a plurality of segmented areas,

the image synthesis section may include:

a plurality of sub-image synthesis sections, each of the plurality of sub-image synthesis sections writing a drawn image into a corresponding segmented area among the plurality of segmented areas; and

a main image synthesis section,

each of the plurality of sub-image synthesis sections may write a drawn image into the corresponding segmented area based on the drawn image data received from an area processing unit among the plurality of area processing units, and

the main image synthesis section may synthesize the drawn images written into the plurality of segmented areas of the reception buffer.

According to this configuration, the image synthesis process can be easily parallelized so that a high-quality display image can be generated by utilizing a plurality of sub-image synthesis devices.

According to another embodiment of the invention, there is provided an image generation method comprising:

causing each of a plurality of area processing units to perform a control process that controls an object positioned in a corresponding area among a plurality of areas, the plurality of areas been formed by dividing a virtual three-dimensional space;

causing each of the plurality of area processing units to perform a drawing process that draws an image of the corresponding area viewed from a virtual camera;

receiving drawn image data when each of the plurality of area processing units has transmitted the drawn image data obtained by the drawing process; and

performing an image synthesis process based on the received drawn image data to generate a display image viewed from the virtual camera.

According to another embodiment of the invention, there is provided a computer program product storing a program code that causes a computer to execute the above information generation method.

The term “computer program product” refers to an information storage medium, a device, an instrument, a system, or the like that stores a program code, such as an information storage medium (e.g., optical disk medium (e.g., DVD), hard disk medium, and memory medium) that stores a program code, a computer that stores a program code, or an Internet system (e.g., a system including a server and a client terminal), for example. In this case, each element and each process according to the above embodiments are implemented by corresponding modules, and a program code that includes these modules is recorded in the computer program product.

Embodiments of the invention are described below. Note that the following embodiments do not in any way limit the scope of the invention laid out in the claims. Note that all elements of the following embodiments should not necessarily be taken as essential requirements for the invention.

### 1. Configuration Example of Image Generation System

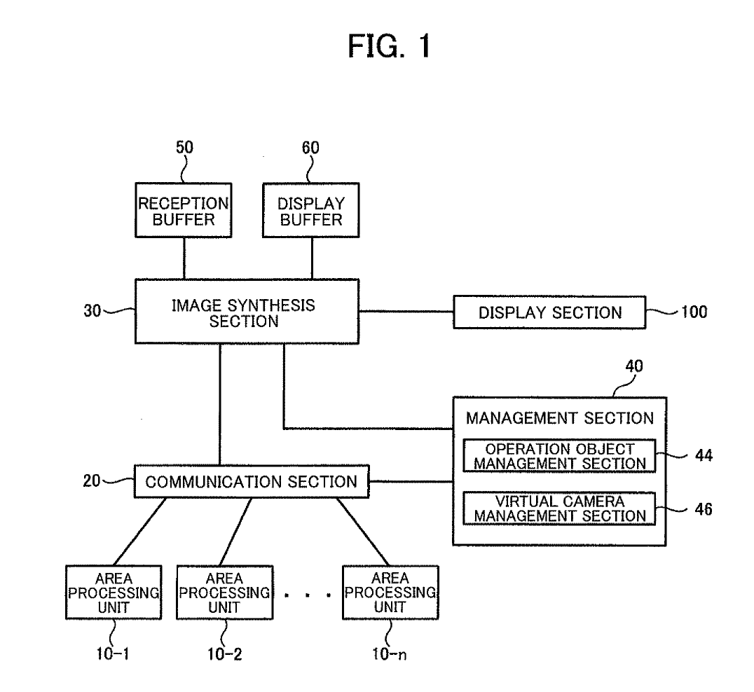

FIG. 1 shows a configuration example of an image generation system according to one embodiment of the invention. The image generation system includes a communication section 20 and an image synthesis section 30. The image generation system may include a plurality of area processing units 10-1 to 10-n and a management section 40. The image generation system may also include a reception buffer 50 and a display buffer 60. Note that the image generation system according to this embodiment is not limited to the configuration shown in FIG. 1. Various modifications may be made, such as omitting some (e.g., area processing unit, management section, reception buffer, or display buffer) of the elements or adding other elements.

Each of the area processing units (grid computers) 10-1 to 10-n (hereinafter may be appropriately referred to as “area processing unit 10”) performs a control process that controls an object that is positioned in the corresponding area among a plurality of areas (e.g., grid areas) formed by dividing a virtual three-dimensional space (game space or game field). Specifically, the area processing unit 10 performs the control process (e.g., movement (i.e., displacement) process and motion process) on an object such as an operation object (e.g., character) or a moving object (e.g., bullet or ball) that is positioned in the corresponding area, for example. The area processing unit 10 also performs a drawing process that draws an image of the corresponding area viewed from a virtual camera. Specifically, the area processing unit 10 draws an image of the corresponding area that is displayed in a display image when viewed from the virtual camera. More specifically, the area processing unit 10 draws an object that is positioned in the corresponding area from the viewpoint of the virtual camera along its line-of-sight direction to generate drawn image data.

The communication section 20 communicates with the outside (e.g., area processing unit or management section) via a cable or wireless network (transmission channel). The function of the communication section 20 may be implemented by hardware (e.g., communication ASIC or communication processor) or communication firmware. Specifically, the communication section 20 receives drawn image data when each area processing unit 10 has performed the drawing process that draws an image of the corresponding area and transmitted the drawn image data obtained by the drawing process.

Note that the network may be a wide area network (WAN) such as the Internet, or may be a local area network (LAN) connected to a wide area network. The network may be a network that connects circuit boards provided with a CPU and a memory, or may be a more local network that connects integrated circuit devices (ICs), for example.

The image synthesis section 30 performs an image synthesis process. Specifically, the image synthesis section 30 performs the image synthesis process based on the drawn image data received from each area processing unit 10 to generate a display image viewed from the virtual camera. More specifically, the image synthesis section 30 synthesizes the drawn images that have been drawn by the area processing units 10-1-10-n to generate a display image (i.e., frame image).

For example, when the communication section 20 has received image data and depth data (e.g., Z-value) from each area processing unit 10 as the drawn image data, the image synthesis section 30 performs the image synthesis process based on the received depth data to generate a display image. The image synthesis section 30 may perform the image synthesis process based on the drawn image data in the order from the area that is positioned away from the virtual camera (e.g., in the order from the area of which the representative point has a Z-value that indicates a position away from the virtual camera).

For example, when the communication section 20 has received drawing area identification information that specifies a drawing area in the display image that has been drawn by each area processing unit 10 (i.e., information that specifies the drawing position or the drawing size) from each area processing unit 10, the image synthesis section 30 synthesizes an image based on the drawn image data received from each area processing unit 10 in the drawing area specified by the received drawing area identification information.

The reception buffer 50 is a buffer into which an image drawn by each area processing unit 10 is written. The display buffer 60 is a buffer used to display a display image. For example, when the communication section 20 has received the drawn image data from each area processing unit 10, the drawn image corresponding to the drawn image data is written into the reception buffer 50. The image synthesis section 30 synthesizes the drawn images written into the reception buffer 50 to generate a display image. The display image is displayed to the operator (player) through a display section 100 using the display buffer 60. The reception buffer 50 and the display buffer 60 may have a double buffer structure in which the reception buffer and the display buffer are alternately replaced by each other.

In this case, a plurality of reception buffers may be provided as the reception buffer 50, and the image synthesis section 30 may write an image obtained by synthesizing the drawn images written into the plurality of reception buffers into the display buffer 60. Alternatively, the reception buffer 50 may be divided into a plurality of segmented areas, and a plurality of sub-image synthesis sections and a main image synthesis section may be provided in the image synthesis section 30. Each sub-image synthesis section may write a drawn image into the corresponding segmented area based on the drawn image data received from the area processing unit 10, and the main image synthesis section may synthesize the drawn images written into the plurality of segmented areas of the reception buffer 50.

The management section 40 performs various management processes. For example, the management section 40 manages the operation object or the virtual camera. An operation object management section 44 manages the operation object, and a virtual camera management section 46 manages the virtual camera.

For example, the management section 40 transmits virtual camera information (viewpoint information and line-of-sight information) to each area processing unit 10. Specifically, the management section 40 acquires the virtual camera information based on information (e.g., movement information) about the operation object (e.g., character) operated by the operator (e.g., player), and transmits the virtual camera information to each area processing unit 10. Each area processing unit 10 draws an image of the corresponding area viewed from the virtual camera based on the received virtual camera information. More specifically, each area processing unit 10 draws an object that is positioned in the corresponding area using the virtual camera that is set to the viewpoint and the line-of-sight direction indicated by the virtual camera information.

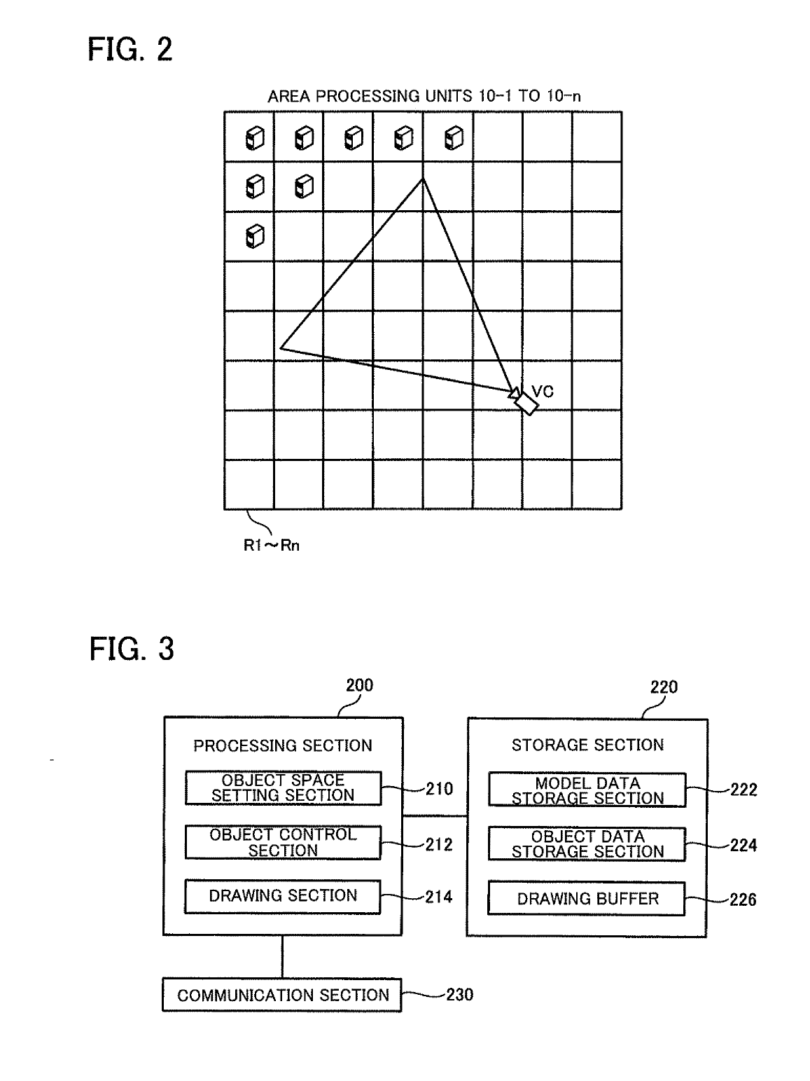

FIG. 2 shows an example of a plurality of areas R1 to Rn and the area processing units 10-1 to 10-n that respectively take charge of the areas R1 to Rn. The areas R1 to Rn are formed by dividing the virtual three-dimensional space (object space or game space). In FIG. 2, the virtual three-dimensional space is divided into a plurality of grid areas. FIG. 2 shows an example in which the virtual three-dimensional space is divided two-dimensionally for convenience. Note that the virtual three-dimensional space may be divided three-dimensionally. For example, the virtual three-dimensional space may be divided into a plurality of areas in the vertical (height) direction. The shape of the area is not limited to the grid shape shown in FIG. 2. Various shapes other than the grid shape may also be employed.

Each of the area processing units 10-1 to 10-n takes charge of the object control process and the object drawing process in the corresponding area among the areas R1 to Rn. For example, the area processing unit 10-1 performs the control process (e.g., movement process and motion process) on an object that is positioned in the area R1. The area processing unit 10-1 draws an object that is positioned in the area R1 from the viewpoint of the virtual camera VC. The area processing unit 10-1 then transmits the resulting drawn image data (i.e., data that indicates the drawn image of the area R1 viewed from the virtual camera VC). The area processing units 10-2 to 10-n that respectively take charge of the areas R2 to Rn operate in the same way as the area processing unit 10-1.

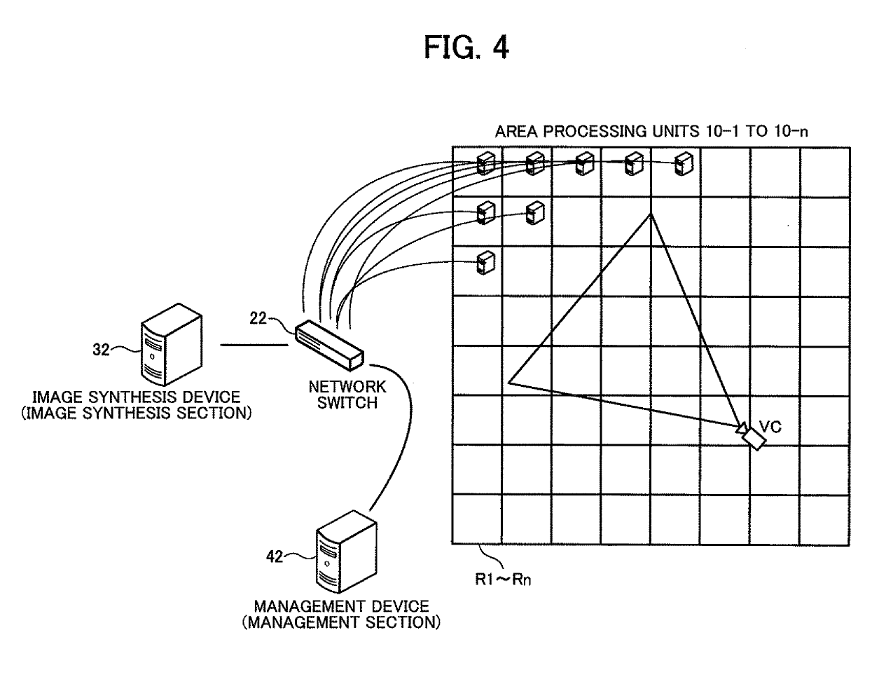

FIG. 3 shows a configuration example of the area processing unit 10. The area processing unit 10 includes a processing section 200, a storage section 220, and a communication section 230. The area processing unit 10 may be implemented by an information processing device (e.g., server), a circuit board provided with a CPU (microcomputer) and a memory, or an integrated circuit device (e.g., processor) that implements parallel computing. Note that the area processing unit 10 is not limited to the configuration shown in FIG. 3. Various modifications may be made, such as omitting some of the elements or adding other elements.

The processing section 200 (processor) performs an object control process, a game process, an image generation process, a sound generation process, and the like based on the virtual camera information, operation information about the operation object (e.g., character), a program, and the like. The processing section 200 performs various processes using the storage section 220 as a work area. The function of the processing section 200 may be implemented by hardware such as a processor (e.g., CPU or GPU) or an ASIC (e.g., gate array) or a program.

The processing section 200 includes an object space setting section 210, an object control section 212, and a drawing section 214. Note that various modifications may be made, such as omitting some of these elements or adding other elements (e.g., game processing section or sound generation section).

The object space setting section 210 disposes an object (i.e., an object formed by a primitive surface such as a polygon, a free-form surface, or a subdivision surface) in an object space (virtual three-dimensional space). Specifically, the object space setting section 210 determines the position and the rotational angle (synonymous with orientation or direction) of the object in a world coordinate system, and disposes the object at the determined position (X, Y, Z) and the determined rotational angle (rotational angles around X, Y, and Z axes). Specifically, model data (e.g., polygon data and texture data) that specifies the shape and the image of a model object is stored in a model data storage section 222 of the storage section 220. Object data that indicates the position, rotational angle, moving speed, moving direction, and the like of the object is stored in an object data storage section 224 of the storage section 220. The object data is sequentially updated by the object control process (movement calculations) performed by the object control section 212. Examples of the object include a moving object (e.g., human, robot, car, fighter aircraft, missile, or bullet) and a stationary object (e.g., map (topography), building, course (road), tree, or wall). An object that is not displayed may also be provided.

The object control section 212 causes the object to move or make a motion. Specifically, the object control section 212 causes the model object (moving object) to move or make a motion (animation) in the object space based on operation information about the operation object received from the management section 40 shown in FIG. 1, a program (movement/motion algorithm), data (motion data), and the like. More specifically, the object control section 212 performs a simulation process that sequentially calculates movement information (position, rotational angle, speed, or acceleration) and motion information (position or rotational angle of a part object) about the object every frame ( 1/60th of a second). The term “frame” refers to a time unit used when performing the object movement/motion process (simulation process) or the image generation process.

For example, the object control section 212 reproduces the motion of the object based on the motion data. Specifically, the object control section 212 reproduces the motion of the object by moving each part object (bone) of the object (i.e., deforming a skeleton) using the motion data that includes the position or the rotational angle (direction) of each part object (bone) that forms the object (skeleton).

The drawing section 214 performs the drawing process that draws an object (e.g., moving object or stationary object). For example, the drawing section 214 performs the drawing process based on the results of various processes (simulation process or game process) performed by the processing section 200 to generate a drawn image. When generating a three-dimensional game image, the drawing section 214 generates vertex data (e.g., vertex position coordinates, texture coordinates, color data, normal vector, or α-value) that indicates each vertex of the object, and performs a vertex process (shading using a vertex shader) based on the vertex data. When performing the vertex process, the drawing section 214 may perform a vertex generation process (tessellation, surface division, or polygon division) for dividing the polygon, if necessary.

In the vertex process (vertex shader process), the drawing section 214 performs a vertex moving process and a geometric process such as coordinate transformation (world coordinate transformation or camera coordinate transformation), clipping, or perspective transformation based on a vertex processing program (vertex shader program or first shader program), and changes (updates or adjusts) the vertex data of each vertex that forms the object based on the processing results. The drawing section 214 then performs a rasterization process (scan conversion) based on the vertex data changed by the vertex process so that the surface of the polygon (primitive) is associated with pixels. The drawing section 214 then performs a pixel process (shading using a pixel shader or a fragment process) that draws the pixels that form the image (fragments that form the display screen).

In the pixel process (pixel shader process), the drawing section 214 determines the drawing color of each pixel that forms the image by performing various processes such as a process of reading a texture stored in a texture storage section (not shown) (texture mapping), a color data setting/change process, a translucent blending process, and an anti-aliasing process based on a pixel processing program (pixel shader program or second shader program). The drawing section 214 then outputs (draws) the drawing color of the model subjected to perspective transformation to a drawing buffer 226 (i.e., a buffer that can store image information corresponding to each pixel; VRAM, rendering target, or frame buffer). Specifically, the pixel process includes a per-pixel process that sets or changes the image information (e.g., color, normal, luminance, and α-value) corresponding to each pixel. The drawing section 214 thus generates an image viewed from the virtual camera (given viewpoint) in the object space.

The vertex process and the pixel process are implemented by hardware that enables a programmable polygon (primitive) drawing process (i.e., a programmable shader (vertex shader and pixel shader)) based on a shader program written in shading language. The programmable shader enables a programmable per-vertex process and per-pixel process to increase the degree of freedom of the drawing process, so that the representation capability can be significantly improved as compared with a fixed drawing process using hardware.

The storage section 220 serves as a work area for a processing section 200, a communication section 230, and the like. The function of the storage section 220 may be implemented by a RAM (DRAM or VRAM) or the like. The model data storage section 222 included in the storage section 220 stores the model data that indicates the object (e.g., a moving object that moves across the areas). The object data storage section 224 stores the object data that is updated in real time.

The communication section 230 communicates with the outside (e.g., communication section 20 or management section 40 shown in FIG. 1) via a cable or wireless network (transmission channel). The function of the communication section 230 may be implemented by hardware (e.g., communication ASIC or communication processor) or communication firmware.

For example, when an operation object (e.g., character) (i.e., an object operated by the operator) is positioned in the area that is taken charge of by the area processing unit 10 and the area processing unit 10 takes charge of the control process on the operation object, the area processing unit 10 transmits the information (movement information that indicates position, direction, and the like) about the operation object after the control process (after the movement process) to the management section 40 shown in FIG. 1 through the communication section 230. When a moving object has moved from one area to another area, the area processing unit 10 that takes charge of the area where the moving object has been positioned notifies the area processing unit that takes charge of the other area with information about the moving object. Specifically, the area processing unit 10 transmits the information about the moving object through the communication section 230 to notify the area processing unit that takes charge of the other area with information about the moving object through the management section 40, for example. In this case, the information about the moving object includes the movement information (e.g., position information and direction information) and the control information (e.g., motion information) about the moving object.

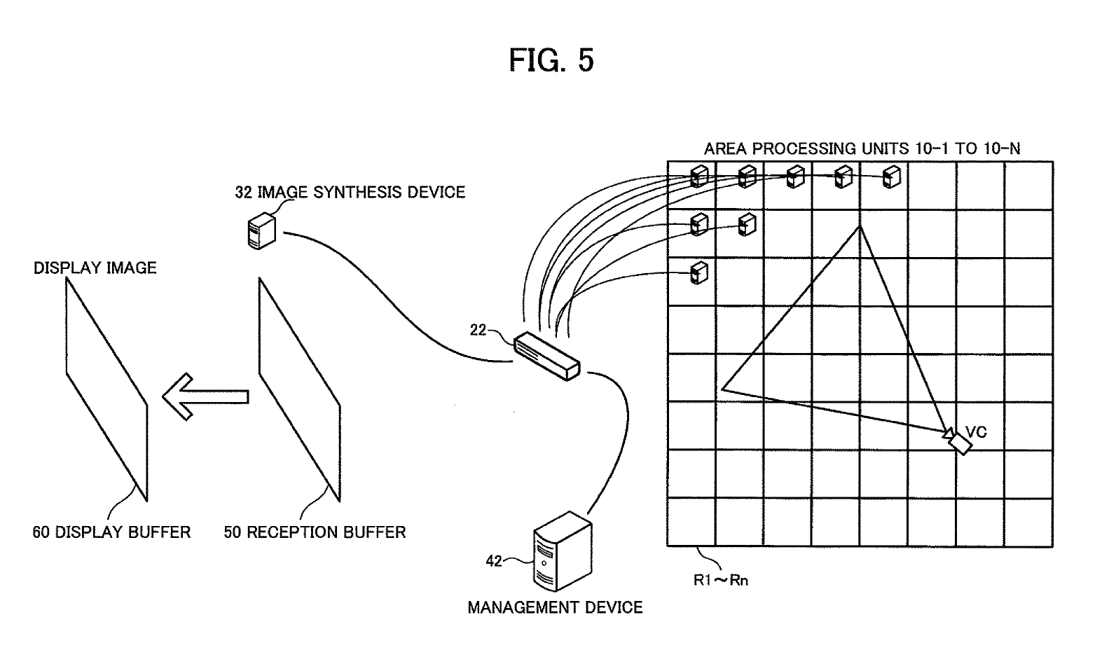

FIG. 4 shows a hardware configuration example of the image generation system according to this embodiment. In FIG. 4, the management section 40 shown in FIG. 1 is implemented by a management device 42 such as a management server, and the image synthesis section 30 is implemented by an image synthesis device 32.

In FIG. 4, each of the area processing units 10-1 to 10-n (grid computers) has information about an object that is positioned in the corresponding area among the areas R1 to Rn (grids). The area processing units 10-1 to 10-n receive information about a virtual camera VC (virtual camera information) from the management device 42 through a network (network switch 22). Each of the area processing units 10-1 to 10-n draws an image of the corresponding area among the areas R1 to Rn viewed from the virtual camera VC, and transmits the resulting drawn image data to the image synthesis device 32 through the network. The image synthesis device 32 then performs the image synthesis process based on the received drawn image data to generate a display image that is displayed on the display section 100.

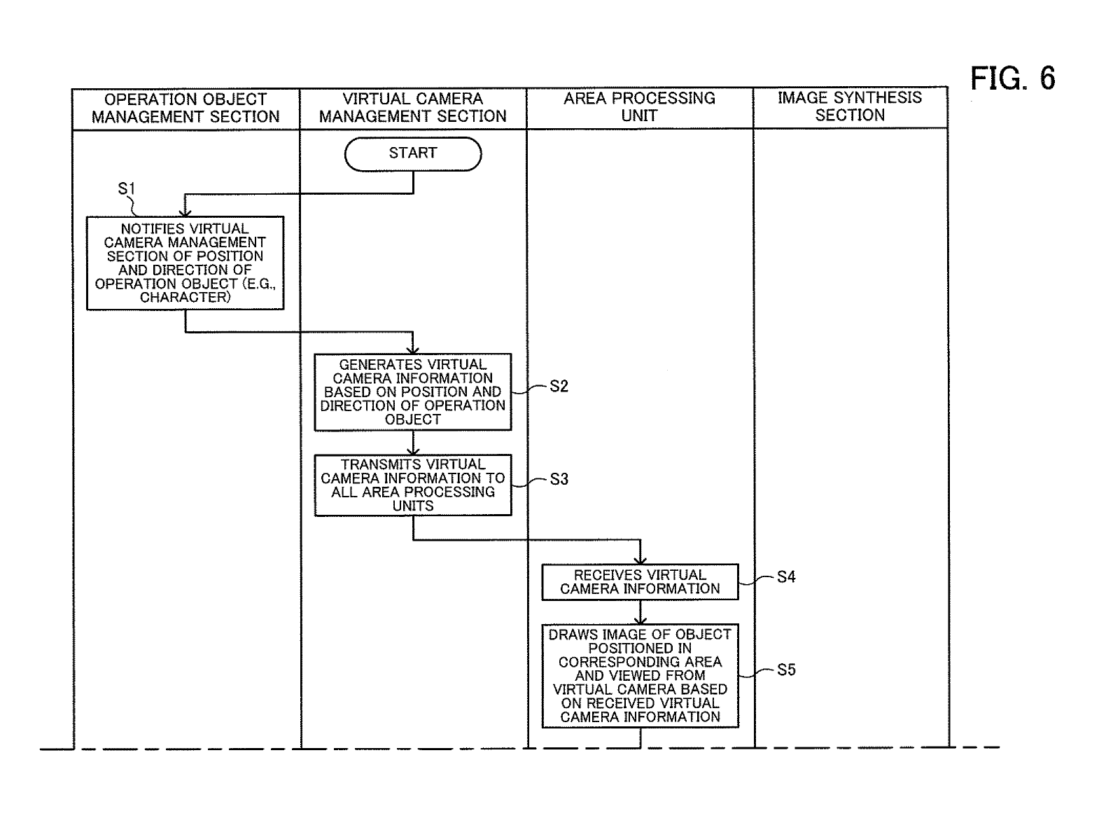

As shown in FIG. 5, a plane is divided into grids, and the area processing units 104 to 10-n are assigned to (disposed (set) corresponding to) the grids. When each area processing unit 10 has received the virtual camera information from the management device 42, each area processing unit 10 renders only an object that is positioned in the corresponding area (grid). When each area processing unit 10 has completed the process, each area processing unit 10 transmits the drawn image data that includes RGB (RGBα) image data and depth data (Z-value) to the image synthesis device 32. Each area processing unit 10 may transmit the drawn image data in which the blank areas (i.e., the areas that are taken charge of by other area processing units 10) are trimmed.

The image synthesis device 32 synthesizes the images drawn by the area processing units 10. When the image synthesis device 32 has completed the image synthesis process, the reception buffer 50 (frame buffer) is switched to the display buffer 60, and a display image is displayed on the display section 100 observed by the operator.

Since the image generation system according to this embodiment is configured so that it suffices that each area processing unit perform the process on only the corresponding area (e.g., grid), each area processing unit can complete the process within a finite short time, so that large-scale parallel computing can be easily implemented. Moreover, since the drawn image data is transmitted from the area processing unit, the amount of data transferred through the network does not exceed the amount of the drawn image data. Therefore, since the data can be transferred within a finite short time, a problem that occurs when the amount of data transferred through the network is insufficient can be prevented. Moreover, since it suffices that the image synthesis device (image synthesis section) synthesize the drawn images transferred from the area processing units, parallel processing is facilitated. Specifically, since it suffices that the image synthesis device perform only the rearrangement process and the image synthesis process based on the depth data corresponding to each pixel, the process can be simplified. According to this embodiment, it becomes possible to execute large-scale calculations within a relatively short time to generate a high-quality video.

Note that the image generation system according to this embodiment may have various hardware configurations. For example, the area processing unit, the image synthesis device, or the management device may be a circuit board provided with a CPU and a memory, or an integrated circuit device. In this ease, the network is implemented by lines provided on the circuit board or connection lines included in the integrated circuit device.

A consumer game device connected to a network (e.g., Internet) may be used as the area processing unit, for example. In this case, consumer game devices that are connected to the network, but do not utilize the network are searched from the network, and are used as the area processing units. A display image generated by the image synthesis section is displayed on a display section (e.g., TV) connected to the consumer game device of the player who utilizes the service. Specifically, when the player has operated the game controller of the consumer game device, the operation information is transmitted to other consumer game devices (i.e., area processing units), and each of these consumer game devices performs the control process and the drawing process on an object that is positioned in the corresponding area. The drawn images based on the processing results are transmitted to an image synthesis server (image synthesis device) managed by the game manufacturer or the like, and the image synthesis server synthesizes the drawn images to generate a display image. The image synthesis server transmits the generated display image to the consumer game device of the player who utilizes the service through the network. This makes it possible to display a high-quality game image on the display section observed by the player.

### 2. Operation

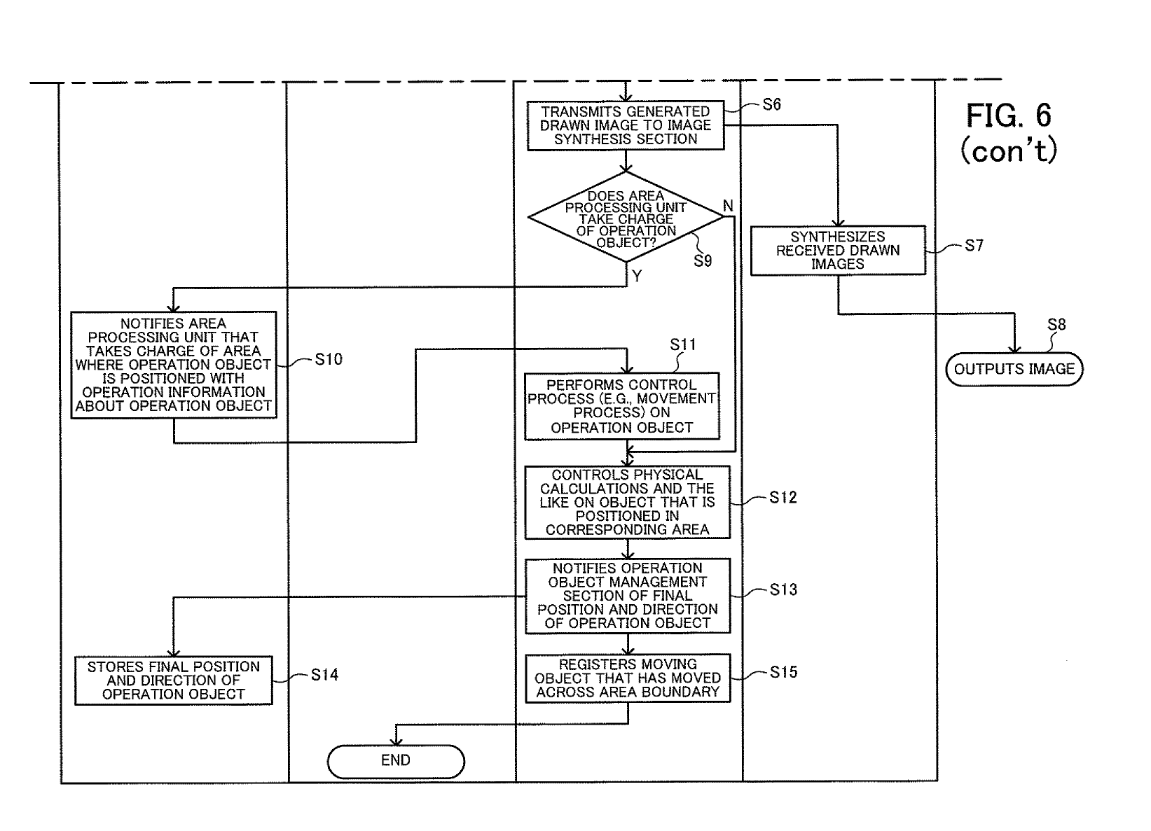

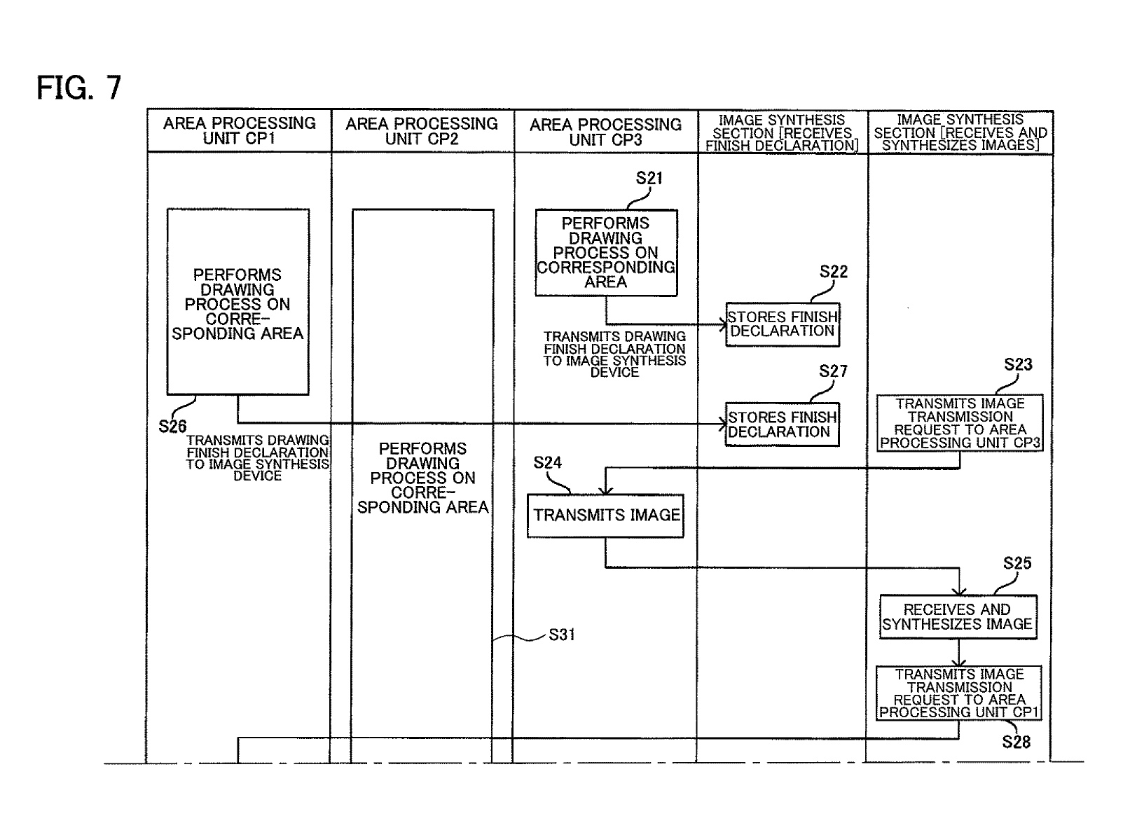

The operation according to this embodiment is described in detail below using data flowcharts shown in FIGS. 6 and 7, etc. FIG. 6 is a data flowchart of the operation object management section 44, the virtual camera management section 46, the area processing unit 10, and the image synthesis section 30 shown in FIG. 1.

The operation object management section 44 notifies the virtual camera management section 46 of the position and the direction of the operation object (e.g., character) operated by the player (step S1). The virtual camera management section 46 then generates the virtual camera information based on the position and the direction of the operation object, and transmits the virtual camera information to the area processing units 10-1 to 10-n (steps S2 and S3). When using a third-person viewpoint, the virtual camera management section 46 calculates the viewpoint position and the line-of-sight direction of the virtual camera so that the virtual camera follows the operation object, for example. When using a first-person viewpoint, the virtual camera management section 46 sets the virtual camera at the viewpoint of the operation object.

When each area processing unit 10 has received the virtual camera information, each area processing unit 10 draws an image of an object that is positioned in the corresponding area and viewed from the virtual camera based on the received virtual camera information (steps S4 and S5). Each area processing unit 10 transmits the generated drawn image to the image synthesis section 30 (image synthesis device 32) (step S6). The image synthesis section 30 synthesizes the received drawn images to generate a display image, and outputs the display image to the display section 100 (steps S7 and S8).

When the area processing unit is a processing unit that takes charge of the operation object (e.g., character), the operation object management section 44 notifies the area processing unit that takes charge of the area where the operation object is positioned, of the operation information about the operation object (steps S9 and S10). Specifically, when the operator (player) has operated the operation object using an operation section (not shown), the area processing unit that takes charge of the area where the operation object is positioned is notified of the operation information.

The area processing unit 10 that has received the operation information performs the control process (e.g., movement process and motion process) on the operation object that is positioned in the corresponding area based on the operation information (step S11). The area processing unit 10 also performs physical calculations and the like on the object (e.g., moving object such as another character or bullet) that is positioned in the corresponding area (step S12). The area processing unit 10 then notifies the operation object management section 44 of the final position and direction of the operation object, and the operation object management section 44 stores the final position and direction of the operation object as the frame information (steps S13 and S14). The operation object management section 44 registers a moving object that has moved from one area to another area (i.e., has moved across the area boundary) in the other area (step 15). Specifically, when a moving object has moved from one area to another area, the operation object management section 44 notifies the area processing unit that takes charge of the other area with information about the moving object.

FIG. 7 is a data flowchart of the area processing units CP1, CP2, and CP3 and the image synthesis section 30. FIG. 7 shows an example in which the number of area processing units is three for convenience.

When the area processing unit CP3 has completed the drawing process on the corresponding area, the area processing unit CP3 transmits a drawing finish declaration to the image synthesis section 30, and the image synthesis section 30 stores the drawing finish declaration (steps S21 and S22). The image synthesis section 30 then transmits an image transmission request to the area processing unit CP3, and the area processing unit CP3 transmits the drawn image (steps S23 and S24). When the image synthesis section 30 has received the image, the image synthesis section 30 synthesizes the image (step S25).

Likewise, when the area processing unit CP1 has completed the drawing process on the corresponding area, the area processing unit CP1 transmits a drawing finish declaration to the image synthesis section 30, and the image synthesis section 30 stores the drawing finish declaration (steps S26 and 527). The image synthesis section 30 then transmits an image transmission request to the area processing unit CP1, and the area processing unit CP1 transmits the drawn image (steps S28 and S29). When the image synthesis section 30 has received the image, the image synthesis section 30 synthesizes the image (step S30).

When the area processing unit CP2 has completed the drawing process on the corresponding area, the area processing unit CP2 transmits a drawing finish declaration to the image synthesis section 30, and the image synthesis section 30 stores the drawing finish declaration (steps S31 and S32). The image synthesis section 30 then transmits an image transmission request to the area processing unit CP2, and the area processing unit CP2 transmits the drawn image (steps S33 and S34). When the image synthesis section 30 has received the image, the image synthesis section 30 synthesizes the image (step S35). The image synthesis section 30 thus synthesizes the images drawn by the area processing units CP1 to CP3 to generate a display image.

In this embodiment, the management section (virtual camera management section) transmits the virtual camera information to each area processing unit (steps S3 and S4 in FIG. 6). Specifically, the management section acquires the virtual camera information based on the information about the operation object (steps S1 and S2), and transmits the virtual camera information to each area processing unit. Each area processing unit draws an image of the corresponding area viewed from the virtual camera based on the received virtual camera information (step S5). According to this configuration, since the virtual camera can be managed (controlled) by the management section, each area processing unit need not manage the virtual camera. Each area processing unit can generate an image of the corresponding area viewed from the virtual camera based on the virtual camera information received from the management section.

The area processing unit that performs the control process on the operation object transmits the information about the operation object after the control process to the management section (operation object management section) (steps S11, S13, and S14). The management section stores the information about the operation object received from the area processing unit. This makes it possible to notify the virtual camera management section (step S1) or the area processing unit (step S10) of the stored information (e.g., position and direction) about the operation object in the next frame, for example. According to this configuration, since the operation object can be managed (controlled) by the management section, each area processing unit 10 need not manage the operation object.

When a moving object has moved from one area to another area, the area processing unit that takes charge of the area where the moving object has been positioned notifies the area processing unit that takes charge of the other area with information about the moving object (step S15).

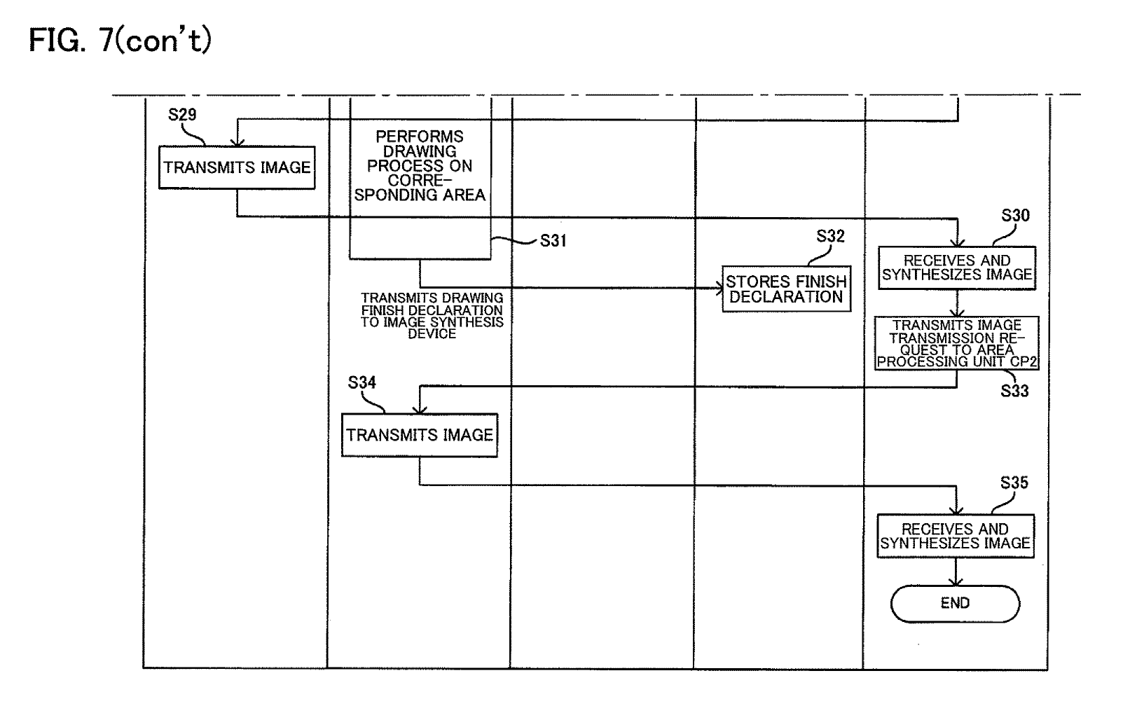

In FIG. 8A, a moving object MOB moves from the area R5 to the adjacent area R4, for example. In this case, the area processing unit that takes charge of the area R5 notifies the area processing unit that takes charge of the area R4 with movement information and control information about the moving object MOB as information about the moving object MOB. As shown in FIG. 8B, the movement information about the moving object MOB includes the position (X, Y, Z), direction (θX, θY, θZ), speed (VX, VY, VZ), acceleration (AX, AY, AZ), and the like of the moving object MOB, The control information about the moving object MOB includes a motion number, a motion matrix (joint angle information), artificial intelligence (AI) information, and the like.

For example, when the moving object MOB is positioned in the area R5, the area processing unit that takes charge of the area R5 controls the moving object MOB. Therefore, the area processing unit that takes charge of the area R4 does not have movement information and control information about the moving object MOB.

According to this embodiment, when the moving object MOB has moved from the area R5 to the area R4, the area processing unit that takes charge of the area R4 is notified of movement information and control information about the moving object MOB. Therefore, the area processing unit that takes charge of the area R4 can take over the physical calculations and the like performed on the area R5 using the movement information (e.g., position, direction, speed, and acceleration) about the moving object MOB. When the motion of the moving object MOB has been reproduced, the area processing unit that takes charge of the area R4 can specify the next motion of the moving object MOB based on the motion number when the moving object MOB has moved from the area R5, and reproduce the motion of the moving object MOB. When a motion generation process that corrects a reference motion by physical calculations and the like has been performed in the area R5, the motion generation process (motion synthesis with the reference motion) can be performed using the motion matrix in the area R5. When the moving object MOB makes a motion based on given AI information, the moving object MOB can be caused to make a motion in the area R4 using the AI information used in the area R5.

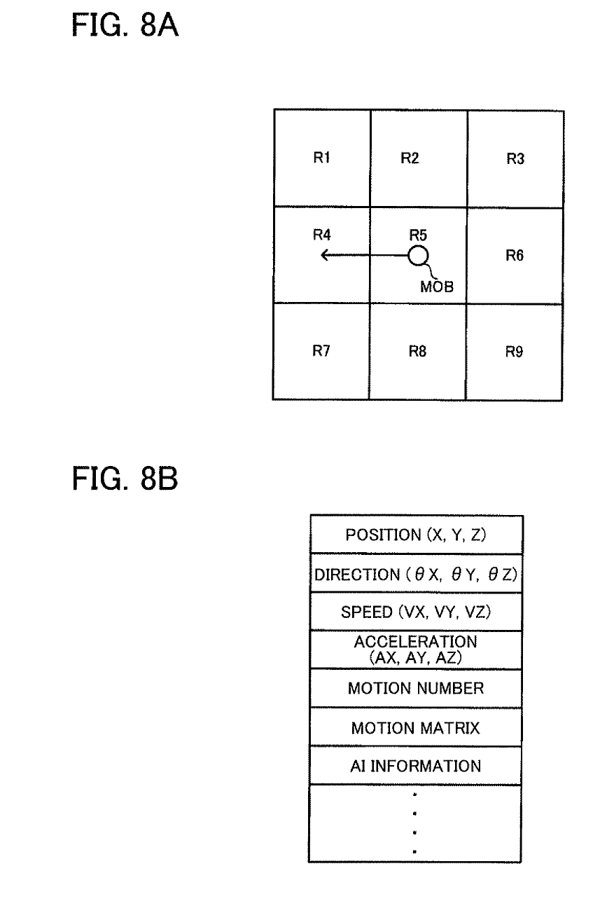

Note that each area may be set to be an enlarged area (buffer area or allowance area) that is larger than the actual area. In FIG. 9, an enlarged area R5′ that is larger than the area R5 is set, for example. The area processing unit that takes charge of the area R5 controls the moving object MOB until the moving object MOB moves beyond the enlarged area R5′. This prevents a situation in which control of the moving object MOB becomes unstable when the moving object MOB moves around the area boundary, for example.

### 3. Image Generation Method

A specific example of the image generation method according to this embodiment is described below.

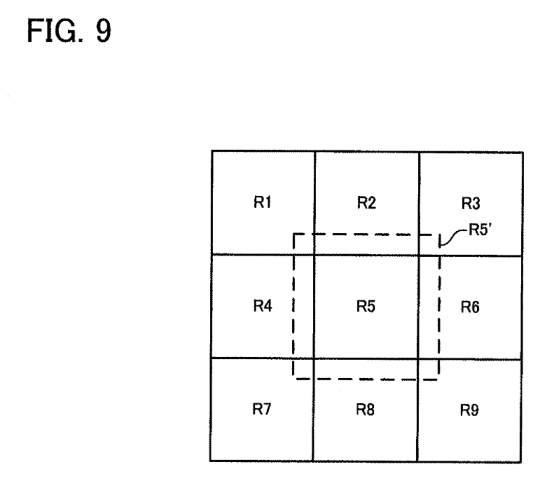

In FIG. 10A, the virtual camera VC that follows the operation object is positioned in the area R5. The objects positioned in the areas R5, R4, R1, and R2 are observed from the viewpoint of the virtual camera VC. In this case, each of the area processing units that respectively take charge of the areas R5, R4, R1, and R2 draws the object that is positioned in the corresponding area from the viewpoint of the virtual camera VC to generate a drawn image viewed from the virtual camera VC. The image synthesis section synthesizes the drawn images generated by the area processing units that respectively take charge of the areas R5, R4, R1, and R2 to generate a display image, as shown in FIG. 5B. Therefore, since the area processing units that respectively take charge of the areas R5, R4, R1, and R2 perform the object control process and the object drawing process in parallel even when a large number of objects are positioned in each of the areas R5, R4, R1, and R2, a high-quality video that cannot be generated by a related-art method can be generated.

Specifically, when a large number of objects (e.g., characters) are positioned in a game field, it is difficult for a related-art image generation system to control all of the objects and generate a high-quality image.

According to this embodiment, since a plurality of area processing units share the control process and the drawing process on a large number of objects, a video in which a large number of objects appear in a game field can be generated. According to this embodiment, such a video can be generated in real time (interactively) without using a pre-rendering process. For example, it is possible to generate a video in which all of the objects in a game field are affected by the operation of the operator performed using an operation section (e.g., game controller). For example, it is possible to generate a video in which all of the objects in a game field are blown away when the operator has performed an operation that explodes a bomb.

An image may be synthesized in various ways based on the drawn image data from the area processing units.

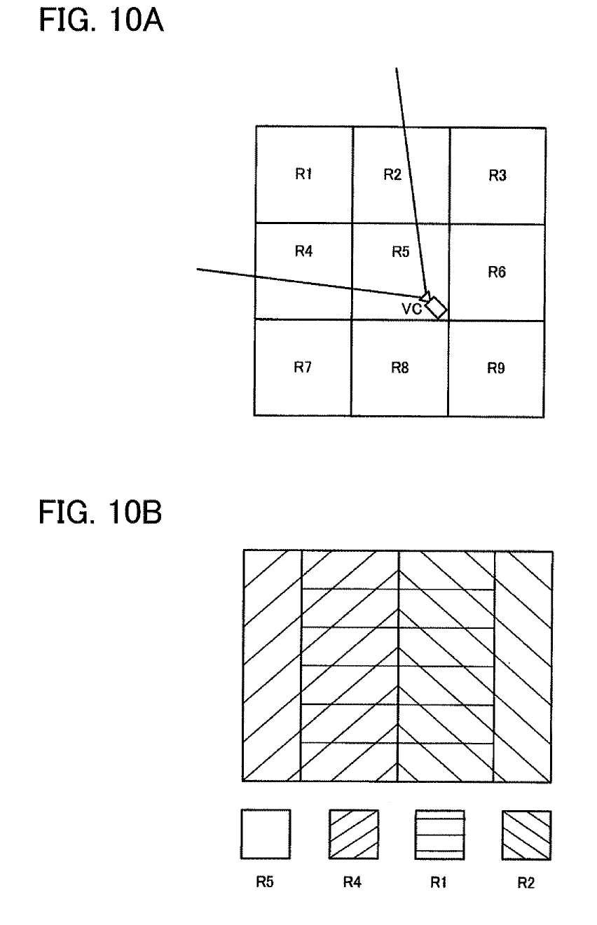

In FIG. 11, the image synthesis section receives image data and depth data from each area processing unit as the drawn image data, for example. Examples of the image data include RGB data and an α-value used for translucent blending. Examples of the depth data include a Z-value used for Z-comparison. When the image synthesis section has received the RGB (RGBα) data and the depth data, the image synthesis section performs the image synthesis process based on the received depth data. Specifically, the image synthesis section performs a Z-comparison process based on the Z-value (i.e., depth data), and draws the RGB data. More specifically, the image synthesis section compares the Z-value of the Z-plane of the original image with the Z-value of the image drawn by each area processing unit, and draws the RGB data from the area processing unit corresponding to a pixel that has been determined to be positioned in front of the virtual camera. In this case, the image synthesis section performs a translucent blending process based on the α-value, if necessary.

According to the method shown in FIG. 11, the drawn images can be synthesized by effectively utilizing the Z-value obtained by the drawing process performed by each area processing unit. In this case, since a hidden surface removal process is performed in pixel units, a high-quality display image can be generated.

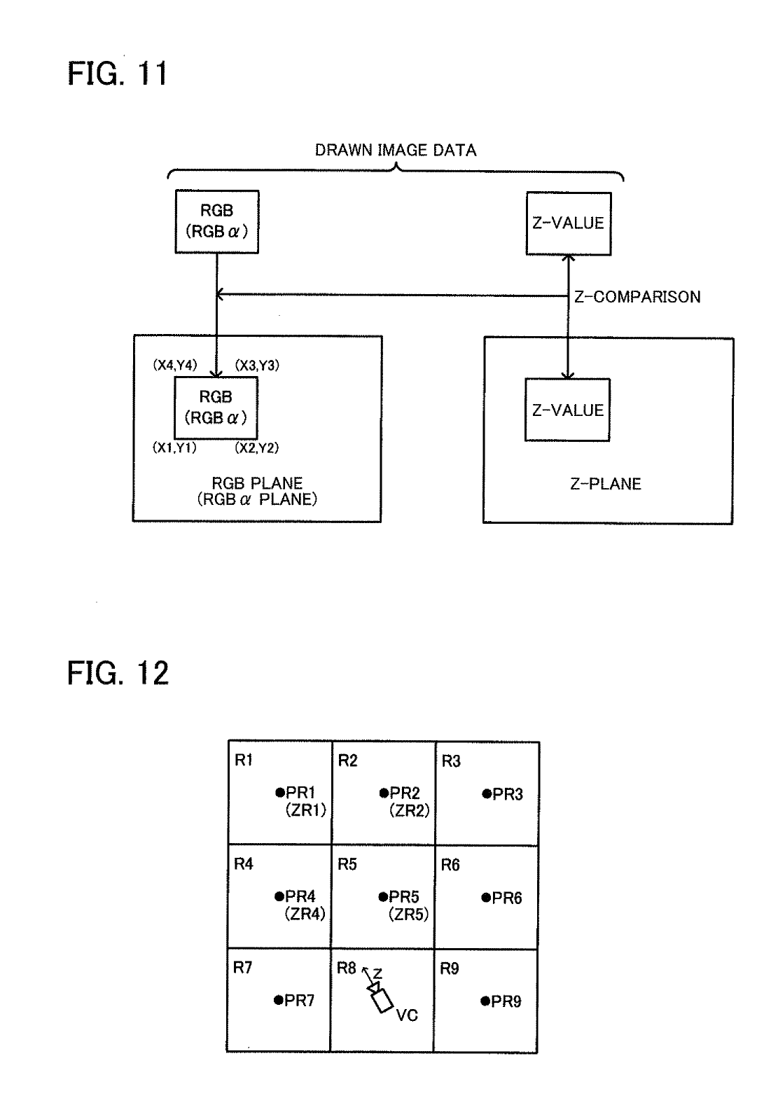

In order to simplify the process and reduce the processing load, the image synthesis section may perform the image synthesis process based on the drawn image data in the order from the area that is positioned away from the virtual camera. In FIG. 12, PR1 to PR9 respectively indicate representative points of the areas R1 to R9, for example. ZR1, ZR2, ZR4, and ZR5 respectively indicate the Z-values of the representative points PR1, PR2, PR4, and PR5 of the areas R1, R2, R4, and R5 in the coordinate system of the virtual camera VC. The image synthesis section determines that the area R1 is positioned away from the virtual camera VC and the area R5 is positioned nearest to the virtual camera VC based on the Z-values ZR1, ZR2, ZR4, and ZR5. In this case, the image synthesis section sequentially draws the image drawn by the area processing unit that takes charge of the area R1, the image drawn by the area processing unit that takes charge of the area R2, the image drawn by the area processing unit that takes charge of the area R4, and the image drawn by the area processing unit that takes charge of the area R5. This implements an appropriate hidden surface removal process even if the Z-value is not included in the drawn image data.

Note that each area processing unit may transmit drawing area identification information that specifies the drawing area of each area processing unit to the image synthesis section. In FIG. 11, the area processing unit transmits the coordinates (X1,Y1), (X2,Y2), (X3,Y3), and (X4,Y4) of the drawing area as the drawing area identification information. In this case, an image of the area other than the drawing area may be trimmed. The image synthesis section synthesizes the image drawn by each area processing unit in the drawing area specified by the drawing area identification information. Therefore, since it suffices that the image synthesis section merely write the drawn image in the area specified by the drawing area identification information, the process can be simplified so that the processing load imposed on the image synthesis section can be reduced.

Note that various types of information may be used as the drawing area identification information. For example, the drawing area may be specified by the origin and the size of the drawing area. Alternatively, a bounding volume that includes the drawing area may be set, and the drawing area may be specified by the bounding volume.

When a large number of area processing units 10-1 to 10-n are connected to the network (network switch 22) (see FIG. 5), a long wait time may occur when writing the drawn image data into the reception buffer due to data transfer through the network.

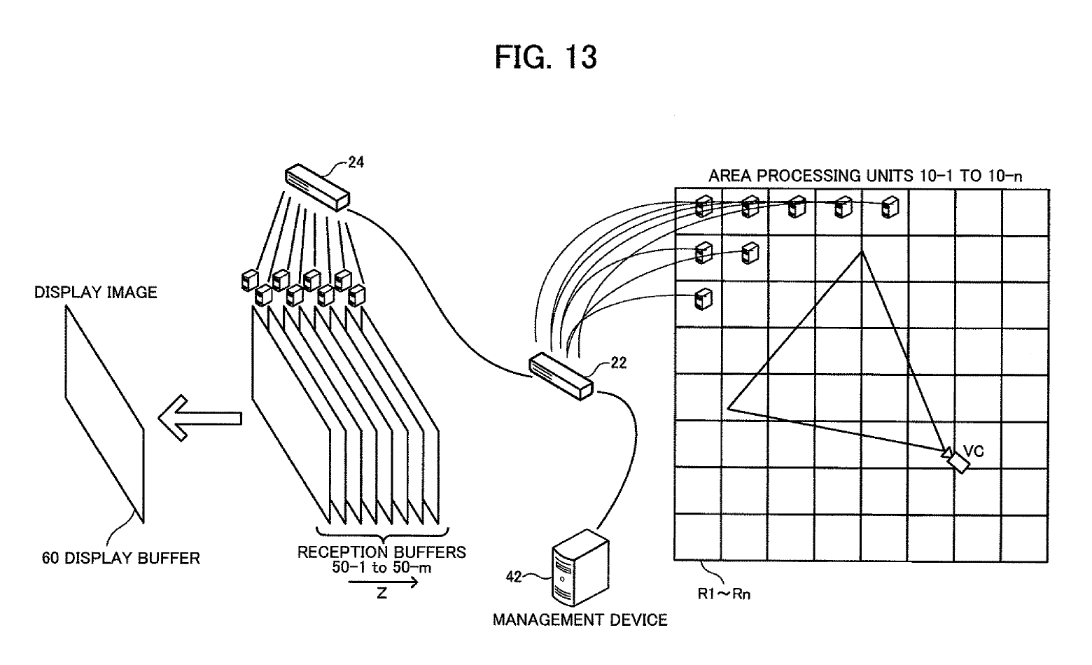

In FIG. 13, a plurality of reception buffers 50-1 to 50-m into which the image drawn by the area processing unit is written are provided. The drawn images written into the reception buffers 50-1 to 50-m are synthesized by a plurality of sub-image synthesis sections provided corresponding to the reception buffers 50-1 to 50-m. For example, when drawn image data has been received from another area processing unit when a first sub-image synthesis device (image synthesis section) is writing a drawn image into the first reception buffer 50-1, a second sub-image synthesis device writes the received drawn image into the second reception buffer 50-2. When drawn image data has been received from still another area processing unit when the second sub-image synthesis device is writing the drawn image into the second reception buffer 50-2, a third sub-image synthesis device writes the received drawn image into the third reception buffer 50-3. The main image synthesis device writes an image obtained by synthesizing the drawn images written into the reception buffers 50-1 to 50-m into the display buffer 60 to generate a display image.

According to this configuration, when a plurality of pieces of drawn image data have been transmitted from a plurality of area processing units at the same time, the drawn image data can be written into the reception buffer while minimizing the wait time. This prevents a situation in which a long wait time occurs when writing the drawn image data into the reception buffer due to data transfer through the network.

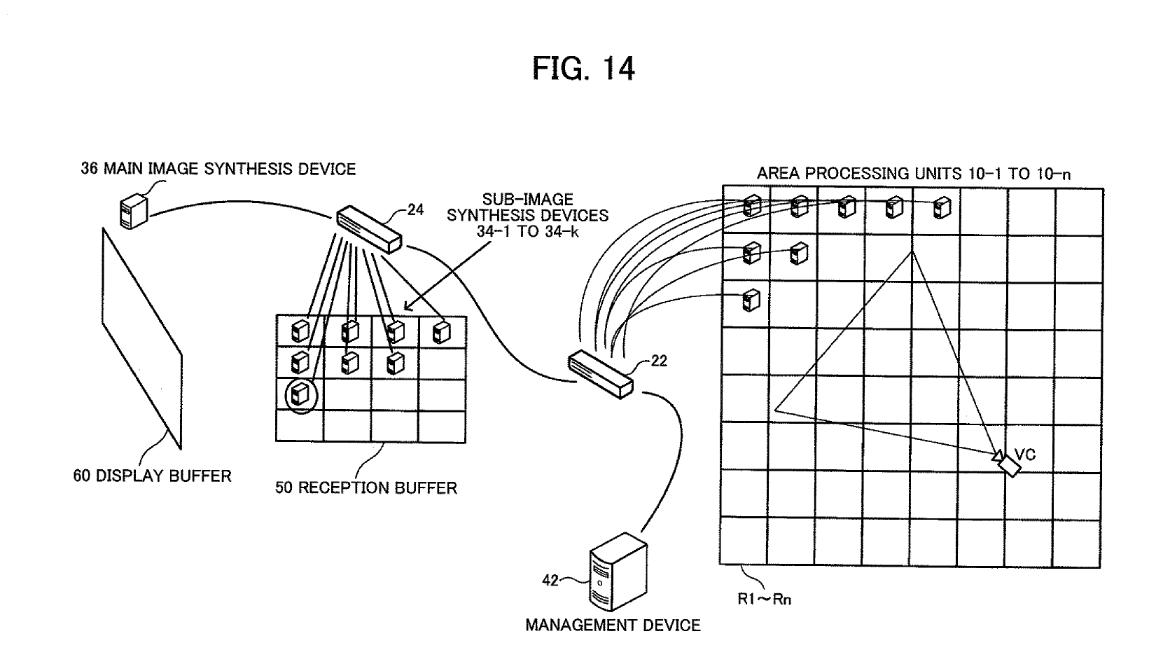

In FIG. 14, the reception buffer 50 is divided into a plurality of segmented areas. Specifically, the reception buffer 50 is divided into a plurality of grids. Each of a plurality of sub-image synthesis devices 34-1 to 34-k writes a drawn image into the corresponding segmented area among the plurality of segmented areas. For example, the first sub-image synthesis device 34-1 takes charge of the first segmented area, and the second sub-image synthesis device 34-2 takes charge of the second segmented area.

Each sub-image synthesis device (sub-image synthesis section) writes the drawn image into the corresponding segmented area based on the drawn image data received from the area processing unit. For example, the first sub-image synthesis device 34-1 receives the drawn image data from the area processing unit, and writes the drawn image data into the first segmented area. The second sub-image synthesis device 34-2 receives the drawn image data from the area processing unit, and writes the drawn image data into the second segmented area.

The main image synthesis device (main image synthesis section) synthesizes the drawn images written into the segmented areas of the reception buffer 50. Specifically, the main image synthesis device writes a display image obtained by synthesizing the drawn images written into the first to kth segmented areas taken charge of by the sub-image synthesis devices 34-1 to 34-k into the display buffer 60.

According to this configuration, since the size of the area taken charge of by each sub-image synthesis device can be reduced, the drawn image can be written within a short time even if the sub-image synthesis device has low performance. Therefore, the image synthesis process can be easily parallelized so that a high-quality display image can be generated by utilizing a plurality of sub-image synthesis devices.

Although some embodiments of the invention have been described in detail above, those skilled in the art would readily appreciate that many modifications are possible in the embodiments without materially departing from the novel teachings and advantages of the invention. Accordingly, such modifications are intended to be included within the scope of the invention. For example, any term cited with a different term having a broader meaning or the same meaning at least once in the specification and the drawings can be replaced by the different term in any place in the specification and the drawings. The image synthesis method, the communication method, the process parallelization method, and the like are not limited to those described with regard to the above embodiments. Methods equivalent to the above methods are included within the scope of the invention.

What is claimed is:

1. An image generation system comprising:
a communication section that receives drawn image data from each of a plurality of area processing units, each of the plurality of area processing units performing a control process that controls an object positioned in a corresponding area among a plurality of areas formed by dividing a virtual three-dimensional space, performing a drawing process that draws an image of the corresponding area viewed from a virtual camera, and transmitting the drawn image data obtained by the drawing process; and
an image synthesis section that performs an image synthesis process based on the drawn image data received by the communication section to generate a display image viewed from the virtual camera.

2. The image generation system as defined in claim 1, further comprising:
a management section that manages the virtual camera,
the management section transmitting virtual camera information to each of the plurality of area processing units, and
each of the plurality of area processing units drawing an image of the corresponding area viewed from the virtual camera based on the virtual camera information received from the management section.

3. The image generation system as defined in claim 2,
the management section acquiring the virtual camera information based on information about an operation object that is operated by an operator, and transmitting the virtual camera information to each of the plurality of area processing units.

4. The image generation system as defined in claim 1, further comprising:
the plurality of area processing units.

5. The image generation system as defined in claim 4, further comprising:
a management section that manages an operation object that is operated by an operator,
an area processing unit among the plurality of area processing units that controls the operation object transmitting information about the operation object after the control process to the management section.

6. The image generation system as defined in claim 4,
when a moving object has moved from one area to another area, a first area processing unit among the plurality of area processing units notifying a second area processing unit among the plurality of area processing units with information about the moving object, the first area processing unit taking charge of the area where the moving object has been positioned, the second area processing unit taking charge of the other area.

7. The image generation system as defined in claim 6,
the first area processing unit notifying the second area processing unit with at least one of movement information and control information about the moving object as the information about the moving object.

8. The image generation system as defined in claim 4,
each of the plurality of area processing units including a model data storage section that stores model data of a moving object that moves across an area boundary.

9. The image generation system as defined in claim 1,
the communication section receiving image data and depth data from each of the plurality of area processing units as the drawn image data, and
the image synthesis section performing the image synthesis process based on the depth data received by the communication section.

10. The image generation system as defined in claim 1,
the image synthesis section performing the image synthesis process based on the drawn image data in the order from an area among the plurality of areas that is positioned away from the virtual camera.

11. The image generation system as defined in claim 1,
the communication section receiving drawing area identification information from each of the plurality of area processing units, the drawing area identification information specifying a different drawing area in the display image where an image has been drawn respectively by each of the plurality of area processing units, and
the image synthesis section synthesizing an image based on the drawn image data received respectively from each of the plurality of area processing units in the drawing area specified by the drawing area identification information received respectively from each of the plurality of area processing units.

12. The image generation system as defined in claim 1, further comprising:
a plurality of reception buffers, a drawn image that has been drawn by each of the plurality of area processing units being written into the plurality of reception buffers; and
a display buffer,
the image synthesis section writing an image obtained by synthesizing the drawn images written into the plurality of reception buffers into the display buffer.

13. The image generation system as defined in claim 1, further comprising:
a reception buffer that is divided into a plurality of segmented areas,
the image synthesis section including:
a plurality of sub-image synthesis sections, each of the plurality of sub-image synthesis sections writing a drawn image into a corresponding segmented area among the plurality of segmented areas; and
a main image synthesis section,
each of the plurality of sub-image synthesis sections writing a drawn image into the corresponding segmented area based on the drawn image data received from an area processing unit among the plurality of area processing units, and
the main image synthesis section synthesizing the drawn images written into the plurality of segmented areas of the reception buffer.

14. An image generation method comprising:
causing each of a plurality of area processing units to perform a control process that controls an object positioned in a corresponding area among a plurality of areas, the plurality of areas been formed by dividing a virtual three-dimensional space;
causing each of the plurality of area processing units to perform a drawing process that draws an image of the corresponding area viewed from a virtual camera;
receiving drawn image data when each of the plurality of area processing units has transmitted the drawn image data obtained by the drawing process; and
performing an image synthesis process based on the received drawn image data to generate a display image viewed from the virtual camera.

15. The image generation method as defined in claim 14, further comprising:
transmitting virtual camera information to each of the plurality of area processing units; and
causing each of the plurality of area processing units to draw an image of the corresponding area viewed from the virtual camera based on the received virtual camera information.

16. The image generation method as defined in claim 14, further comprising:
receiving image data and depth data from each of the plurality of area processing units as the drawn image data; and
performing the image synthesis process based on the received depth data.

17. The image generation method as defined in claim 14, further comprising:
performing the image synthesis process based on the drawn image data in the order from an area among the plurality of areas that is positioned away from the virtual camera.

18. The image generation method as defined in claim 14, further comprising:
receiving drawing area identification information from each of the plurality of area processing units, the drawing area identification information specifying a different drawing area in the display image where an image has been drawn respectively by each of the plurality of area processing units; and
synthesizing an image based on the drawn image data received respectively from each of the plurality of area processing units in the drawing area specified by the drawing area identification information received respectively from each of the plurality of area processing units.

19. The image generation method as defined in claim 14, further comprising:
writing a drawn image that has been drawn by each of the plurality of area processing units into a plurality of reception buffers; and
writing an image obtained by synthesizing the drawn images written into the plurality of reception buffers into a display buffer.

20. A computer program product storing a program code that causes a computer to execute the information generation method as defined in claim 14.
